(19) United States
(12) Patent Application Publication
(10) Pub. No.: US 2015/0367552 A1
(43) Pub. Date: Dec. 24, 2015

(54) HEATING DEVICE AND STRAPPING BAND MANUFACTURING APPARATUS INCLUDING THE SAME

(71) Applicant: DAE EUN INDUSTRIAL CO., LTD., Gyeonggi-do (KR)

(72) Inventors: Jong Woong KIM, Seoul (KR); Tae Woong KIM, Seoul (KR)

(21) Appl. No.: 14/743,108

(22) Filed: Jun. 18, 2015

(30) Foreign Application Priority Data
Jun. 18, 2014 (KR) 10-2014-0074535

(51) Int. Cl. B29C 47/88; F27B 9/38; F27B 9/28; F27B 9/36; B29C 47/00; F27B 9/24

(52) U.S. Cl. CPC B29C 47/8805; B29C 47/0021; B29C 47/8845; F27B 9/2407; F27B 9/28; F27B 9/36; F27B 9/38; B29K 2023/12

(57) ABSTRACT

In the case of the heating device and a packing band manufacturing apparatus including the same, since it is possible to heat, cool, and heat a band stock without cooling the inside of the housing in one heating device, it is unnecessary to provide a plurality of heating devices to reheat the band stock and it is possible to omit a pressing device for catching the band stock in order not to allow the band stock between the heating devices to droop, thereby simplifying equipment.

### CROSS-REFERENCE TO RELATED APPLICATION

This application claims priority to and the benefit of Korean Patent Application No. 10-2014-0074535, filed on Jun. 18, 2014, the disclosure of which is incorporated herein by reference in its entirety.

### BACKGROUND

1. Field of the Invention

The present invention relates to a heating device and a strapping band manufacturing apparatus including the same.

2. Discussion of Related Art

Generally, strapping bands are used to pack heavy and large home appliances in packing boxes, industrial materials such as pipes, and materials for construction such as timber, stone, and bricks, which are loaded, while preventing products from leaving therefrom. Not only elastic force and tensile force but also corrosion resistance, thermal resistance, safety, and eco-friendliness are necessary for bands used for packing boxes or used while packing products. Generally, depending on products to be packed, polypropylene bands or steel bands are used.

Polypropylene bands and steel bands used for packing bands described above include several limitations, which will be described in detail as follows.

First, polypropylene bands repetitively shrink and swell when exposed to external shock, humidity, and ultraviolet (UV) rays while being used for parking products and transferred (during a transportation and storage process) in such a way that polypropylene bands firmly banded become loose or snapped, thereby allowing loaded products to be scattered to be damaged or deteriorated in safety.

Also, due to a heavy weight of wound steel bands, extreme stability is necessary to handle steel bands, more risks are present in packing or unpacking, and there are present difficulties for cutting. Accordingly, when packing using steel bands, several cautions are necessary to pack using steel bands.

For example, when to perform a packing operation through loading industrial materials or materials for construction such as pipes and timber, to prevent scattering of loaded products, loaded products are strongly banded using steel bands. Due to sharp edges, loaded products such as pipes and timber are damaged such as being scratched.

Also, when packed products are exposed to humidity or UV rays, rust oozes from steel bands and makes products dirty to be damaged. Also, while transporting products packed using steel bands through a vehicle such as a forklift, when the forklift treads on a place on which residual steel bands are disposed, tires of the forklift were damaged.

For example, due to sharp edges of the steel bands, packed products may be damaged while workers may be damaged during a packing process, thereby causing deterioration in working efficiency. In addition, it is impossible to incinerate or reuse residual steel bands left after packing products or used steel bands, which pollutes environment.

Additionally, recently, engineering plastic capable of replacing steel or polypropylene has been applied to various types of mechanical components. Polyethylene terephthalate (PET) obtained through a condensation reaction between terephthalic acid and ethylene glycol is one thereof. This is generally used for fiber and additionally used as films or thermoplastic materials and able to maintain 80% of intensity of steel bands due to excellent tensile strength and wear resistance thereof

Researches on apparatuses for manufacturing packing bands described above have been performed. Korean Patent Registration Publication No. 10-0647217 discloses a dry elongation apparatus for forming packing bands.

### SUMMARY OF THE INVENTION

The present invention is directed to a heating device capable of reducing a plurality of processes of heating, pressurizing, cooling, and reheating a band stock into one process and a packing band manufacturing apparatus including the heating device.

According to an aspect of the present invention, there is provided a heating device including a housing through which a band stock is input and output, a main roller provided to traverse the inside of the housing to allow the band stock to hang thereover, inside which a refrigerant circulates to maintain a surface temperature thereof to be lower than an internal temperature of the housing, a rotary joint unit which traverses the inside of the main roller to be interconnected with the main roller to allow the refrigerant to flow through and circulate the inside of the main roller, a guide roller separate from the main roller to allow top and bottom thereof to cross each other in the housing, over which the band stock hangs, and a heating unit which heats the inside of the housing, in which the band stock input into the housing is heated by the heating unit, turns around the guide roller, is wound around the main roller to be cooled by the surface temperature of the main roller, is reheated by the heating unit, and is discharged from the housing, or is heated by the heating unit, turns around the main roller to be cooled by the surface temperature of the main roller, is wound around the guide roller, is reheated by the heating unit, and is discharged from the housing.

According to another aspect of the present invention, there is provided a packing band manufacturing apparatus including, a hopper through which a raw material is input, an extruder which receives the raw material from the hopper and extrude the raw material to discharge a band stock, a cooling device through which the band stock passes to be hardened, and a heating device which receives the band stock from the cooling device and heats the band stock, in which the heating device includes a housing through which the band stock is input and output, a main roller provided to traverse the inside of the housing to allow the band stock to hang thereover, inside which a refrigerant circulates to maintain a surface temperature thereof to be lower than an internal temperature of the housing, a rotary joint unit which traverses the inside of the main roller to be interconnected with the main roller to allow the refrigerant to flow through and circulate the inside of the main roller, a guide roller separate from the main roller to allow top and bottom thereof to cross each other in the housing, over which the band stock hangs, and a heating unit which heats the inside of the housing, in which the band stock input into the housing is heated by the heating unit, turns around the guide roller, is wound around the main roller to be cooled by the surface temperature of the main roller, is reheated by the heating unit and is discharged from the housing, or is heated by the heating unit, turns around the main roller to be cooled by the surface temperature of the main roller, is wound around the guide roller, is reheated by the heating unit and is discharged from the housing.

The rotary joint unit may include a screw portion rotary jointed with the main roller to rotate the main roller, a refrigerant inlet through which the refrigerant is supplied to the main roller, and a refrigerant outlet through which the refrigerant is discharged from the main roller.

The heating device may further include a pressing roller provided on one side of one of the main roller and the guide roller to be in contact therewith disposing the band stock therebetween.

The pressing roller may be provided on one side of one of the main roller and the guide roller and an elongation roller may be further provided on one side of the other of the main roller and the guide roller.

The heating device may further include driving units which rotate the main roller and the guide roller, respectively, in which a rotational speed of the main roller driven by the driving unit may be higher than a rotational speed of the guide roller driven by the driving unit to elongate the band stock.

The housing may include a frame including an inlet through which the band stock is input, an outlet through which the band stock is discharged, and an opening, a door which opens and closes the opening and brackets provided on the frame to support the main roller and the guide roller, respectively.

The door may include a projective window through which the inside of the housing is projected outside.

The housing may include lagging which prevents the heated internal temperature from escaping.

The internal temperature of the housing may be from about 100° C. to about 130° C., and the temperature of the main roller may be from about 50° C. to about 80° C.

The refrigerant may be formed of oil.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual view of a general packing band manufacturing apparatus;

FIG. 2 is a conceptual view of a packing band manufacturing apparatus according to one embodiment of the present invention;

FIG. 3 is a front view of a heating device of the packing band manufacturing apparatus according to one embodiment of the present invention;

FIG. 4 is a conceptual side view of a door provided in the heating device of the packing band manufacturing apparatus according to one embodiment of the present invention;

FIG. 5 is a front view of a bracket provided in the heating device of the packing band manufacturing apparatus according to one embodiment of the present invention;

FIG. 6 is a top configuration view of the heating device of the packing band manufacturing apparatus according to one embodiment of the present invention;

FIG. 7 is a conceptual view illustrating the inside of the heating device of the packing band manufacturing apparatus according to one embodiment of the present invention;

FIG. 8 is a view illustrating a separate state of a main roller and a rotary joint unit provided in the heating device of the packing band manufacturing apparatus according to one embodiment of the present invention;

FIG. 9 is a view illustrating a coupled state of the main roller and the rotary joint unit provided in the heating device of the packing band manufacturing apparatus according to one embodiment of the present invention;

FIG. 10 is a view illustrating oil circulation of the main roller and the rotary joint unit provided in the heating device of the packing band manufacturing apparatus according to one embodiment of the present invention;

FIG. 11 is a view illustrating an arrangement of ceramic heaters provided in the heating device of the packing band manufacturing apparatus according to one embodiment of the present invention; and

FIG. 12 is a conceptual view illustrating the inside of a heating device of a packing band manufacturing apparatus according to another embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Aspects, particular effects, and technical features of the present invention will be apparent by a following detailed description related to the attached drawings and exemplary embodiments of the present invention. Throughout the drawings, while assigning reference numerals to elements, even when shown in different drawings, like reference numerals designate like elements. While describing the embodiments, when it is determined that a detailed description of components or functions well known in the art may unnecessarily obscure the points of the present embodiment, the detailed description thereof will be omitted.

Hereinafter, the exemplary embodiments of the present invention will be described in detail with reference to the attached drawings.

FIG. 1 is a conceptual view of a general packing band manufacturing apparatus 1.

As shown in FIG. 1, the general packing band manufacturing apparatus 1 includes a hopper 2, an extruder 3, a cooling device 4, a first elongation device 5, a first oven 6, a pressing device 7, a second oven 6A, and a second elongation device 5A.

A process of producing packing bands using the general packing band manufacturing apparatus 1 will be performed as follows.

A raw material supplied through the hopper 2 is heated at the extruder 3 to be formed as a band stock 10. The formed band stock 10 supplied from the extruder 3 is hardened while passing through cooling water of the cooling device 4. The hardened band stock 10 is moved to the first elongation device 5 to be elongated.

Here, the first elongation device 5 compresses the band stock 10, thereby elongating a length thereof and supporting the band stock 10.

The band stock 10 elongated at the first elongation device 5 is moved to the first oven 6 to be heated at a temperature appropriate for performing elongation, passes through the pressing device 7, is reheated at the second oven 6A, and is secondarily elongated at the second elongation device 5A, thereby being manufactured as a packing band 11.

Here, the first oven 6, the pressing device 7, and the second oven 6A are provided and the band stock 10 is discharged from the first oven 6 to be cooled by the air, and then passes through the pressing device 7, and is input to the second oven 6A to be reheated. This is to reduce the damage of being snapped by preventing excessive elongation of the band stock 10 through heating, cooling, and heating processes.

However, in the case of the packing band manufacturing apparatus 1, to repetitively perform heating, cooling, and heating processes upon the band stock 10, it is necessary not only to include a plurality of the first and second ovens 6 and 6A but also to further include the pressing device 7 to prevent the band stock 10 passing between the first and second ovens 6 and 6A from drooping. Accordingly, the number of devices increases and a larger space is necessary, which needs to be improved.

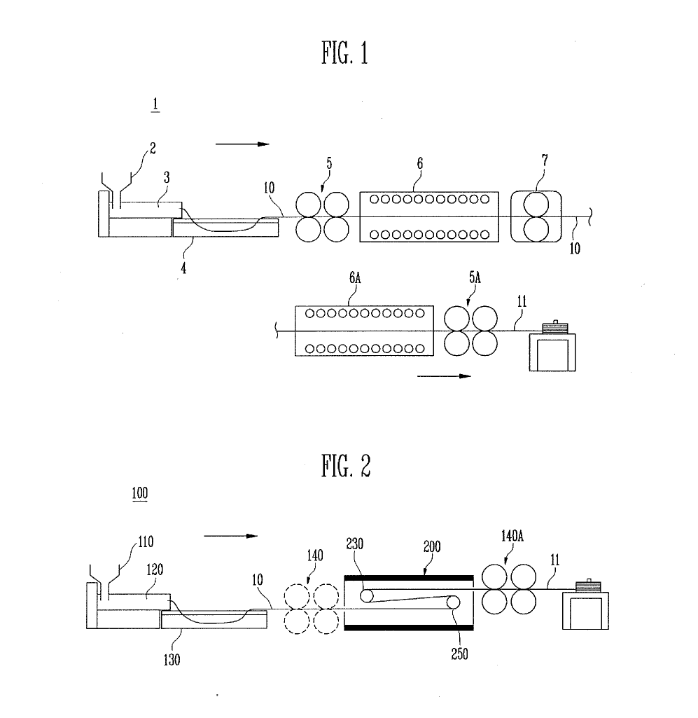

FIG. 2 is a conceptual view of a packing band manufacturing apparatus 100 according to one embodiment of the present invention.

As shown in FIG. 2, the packing band manufacturing apparatus 100 may include a hopper 110, an extruder 120, a cooling device 130, elongation devices 140 and 140A, and a heating device 200.

The hopper 110 and the extruder 120 are components for forming a raw material into a hand stock 10 having a band shape, in which when the raw material is input into the hopper 110, a screw (not shown) in the hopper 110 rotates, thereby pulverizing the raw material. Also, the raw material pulverized at the hopper 110 is heated and melted by a heater (not shown) of the extruder 120 and then extruded as the band shape. In addition, an additive may be input into the extruder 120 to allow a purchaser to add a desirable dye.

The cooling device 130 receives and hardens the band stock 10 formed at the extruder 120. For example, the cooling device 130 includes a water tank and stores cooling water in the water tank.

The cooling device 130 allows the band stock 10 to pass through the cooling water in the water tank of the cooling device 130, before the band stock 10 supplied from the extruder 120 is transferred to the heating device 200, to harden the band stock 10 to have a uniform molecule arrangement.

The band stock 10 which passes through the cooling device 130 is in a state before having the form of a product and does not need to be tightened. Accordingly, the band stock 10 discharged from the extruder 120 may be moved while falling and soaking in the cooling device 130 as a loose shape.

The cooling device 130 described above includes a heat sensor (not shown) to maintain a regular temperature in such a way that when it is more or less than a set temperature, a cooler (not shown) such as a cooling wire provided in the cooling device 130 may be turned on/off.

Here, a temperature of the cooling water in the cooling device 130 is within a range from about 20° C. to about 25° C. to allow the band stock 10 to be slowly cooled, thereby preventing the band stock 10 from snapping caused by rapid cooling. Also, the cooling water may thermally exchanged with a refrigerant supplied to a main roller 230 which will be described below, through a thermal exchanger (not shown) additionally provided outside the cooling device 130. This is to reduce energy consumption by performing thermal exchange between the cooling water and the refrigerant of the main roller 230. However, in the embodiment of the present invention, a thermal exchange direction between the cooling water and the refrigerant is not particularly limited and thermal exchange may be naturally performed depending on a temperature difference.

The heating device 200 is a component for heating the band stock 10 which passes through the extruder 120 and the cooling device 130 to be formed and hardened to allow the band stock 10 to be easily elongated.

The heating device 200 may include an outer case (not shown) to reduce an effect of a temperature change depending on season and will be described below in detail.

The elongation devices 140 and 140A are components for elongating the band stock 10 and may be provided in a downstream portion of the heating device 200 in a moving direction of the band stock 10. The elongation device 140A provided in the downstream portion of the heating device 200 receives the band stock 10 supplied from an outlet 211B of the heating device 200, which is fully heated.

The band stock 10 heated at the heating device 200 is supplied to the elongation device 140A to be compressed to be elongated and a length thereof increases. For example, the elongation device 140A may include a plurality of rollers whose reference numerals are not shown in the drawings. The plurality of rollers are provided top and bottom to catch and push the band stock 10 and additionally may be provided as a plurality thereof on both left and right sides in FIG. 2. Here, the rollers on both left and right sides roll at mutually different rotational speeds. For example, the rollers next to an inlet of the elongation device 140A through which the band stock 10 is supplied may roll at a lower speed than that of the rollers next to an outlet of the elongation device 140A through which the band stock 10 is discharged. Accordingly, a rear side of the band stock 10 pressurized and pushed by the rollers next to the inlet is pulled due to a different speed from a front side of the band stock 10 pressurized and moved in a moving direction by the rollers next to the outlet, thereby performing elongation.

Here, not only the elongation device 140A is provided in the downstream portion of the heating device 200 but also the elongation device 140 is provided in a downstream portion of the cooling device 130, thereby performing elongation at the front and rear of the heating device 200 and moving the band stock 10 supplied to the heating device 200 through the elongation device 140.

The band stock 10 which passes through the cooling device 130 and is supplied to the elongation device 140 is cooled through the cooling device 130 but still has a temperature obtained at the extruder 120, thereby forming a temperature from about 40 to about 80° C. to perform elongation. In the embodiment of the present invention, the omission of the elongation device 140 provided before the heating device 200 will be described below.

As described above, the raw material supplied to the hopper 110 is formed into the band stock 10 at the extruder 120, hardened at the cooling device 130, and then elongated at the elongation device 140 or directly supplied to the heating device 200 to be heated. After that, the band stock 10 is elongated at the elongation device 140A and completed with manufacturing, thereby producing a packing band 11 which is a product.

The packing band 11 is wound by a winding device whose reference numeral is not shown in the drawing to be packed. Here, when one time of drying or a drying process of the raw material is omitted in a process between the hopper 110 and the extruder 120, the packing band 11 may be formed as a polypropylene (PP) band whose strength is about 150 kg.

On the other hand, when two or more drying processes of the raw material are performed in the process between the hopper 110 and the extruder 120, the packing band 11 may be formed as a polyethylene terephthalate (PET) band whose strength is about 300 kg. The PET band whose strength is twice that of the PP band may be used as a substitute for a steel band.

The packing band manufacturing apparatus 100 according to one embodiment of the present invention may omit the elongation device 140 capable of catching the band stock 10 to be supplied to the heating device 200 and may reduce a plurality of processes of heating, pressurizing, and heating the band stock 10 into one process at the heating device 200, thereby simplifying equipment, reducing manufacturing costs, and improving space utilization. In relation thereto, the heating device 200 will be described with reference to the drawings.

FIGS. 3 to 11 are views of the heating device 200 of the packing band manufacturing apparatus 100 according to one embodiment of the present invention. FIG. 12 is a conceptual view illustrating the inside of a heating device 201 of a packing band manufacturing apparatus according to another embodiment of the present invention.

As shown in FIGS. 3 to 11, the heating device 200 includes a housing 210, driving units 220, 220A, the main roller 230, a rotary joint unit 240, a guide roller 250, and a heating unit 260.

As shown in FIG. 3 which is a front view of the heating device 200, the housing 210 may be formed as a rectangular parallelepiped long in the moving direction of the band stock 10 and include a space through which the band stock 10 is input and output. A temperature of the inside of the housing 210 described above may be from about 100° C. to about 130° C. To allow the temperature of the inside of the housing 210 to be maintained within a certain temperature range by the heating unit 260, a heat sensor (not shown) which measures the temperature of the inside of the housing 210 is provided in the housing 210 in such a way that the heating unit 260 is turned on/off when it is more or less than a set temperature.

Here, the housing 210 may include a frame 211, a door 212, and a bracket 213. Lagging (not shown) is provided inside and outside the housing 210 and capable of preventing heat inside from escaping.

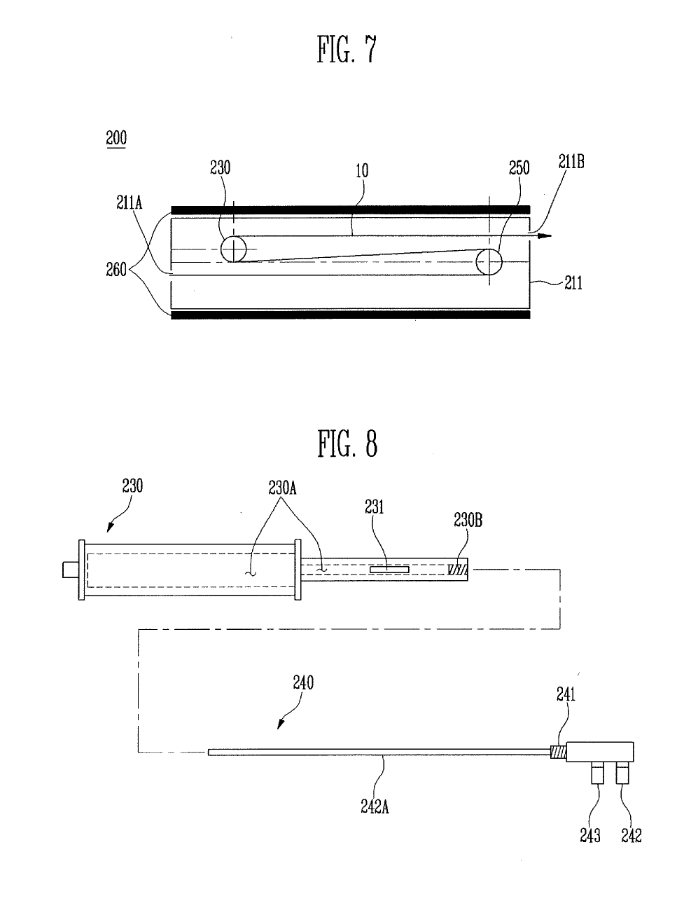

The frame 211 is a component for forming an exterior of the housing 210 and includes an inlet 211A through which the hardened band stock 10 is supplied and the outlet 211 B through which the band stock 10 heated inside the housing 210 is discharged. Here, the inlet 211A and the outlet 211B are opposite to each other, that is, in the left and right of the frame 211 in FIG. 7 to allow the band stock 10 to be supplied to the left and to be discharged from the right. Hereby, the cooling device 130 and a pressing device 140 may be allowed to be disposed in a row together with the heating device 200. Also, the frame 211 may include an opening 211C in front thereof on which the door 212 is mounted, and a cover 210A on a top thereof, which opens the inside of the frame 211 to be checked.

The door 212 may open and close the opening 211 C to manage the inside of the housing 210. The door 212 may include a projective window 212A through which the inside of the housing 210 is projected to the outside to be checked. The projective window 212A is provided in a position to catch sight of the main roller 230 to check the main roller 230. Also, when internal components of the housing 210 such as the heating unit 260 and the heat sensor do not work or there is a fault in entrance conditions of the band stock 10, a worker is allowed to open the door 212 and to easily handle corresponding thereto.

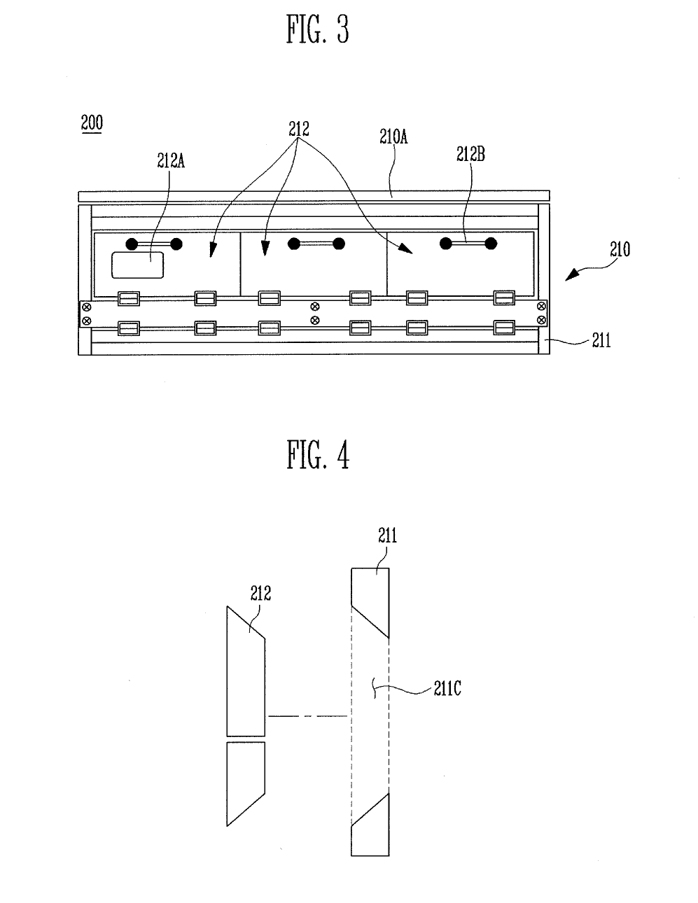

As shown in FIG. 4 which is a side view of the door 212, four sides of the door 212 may slant to allow widths thereof to become narrower from the front toward the rear when the opening 211C is closed, in which the frame 211 may be tapered corresponding to the door 212. As described above, due to the tapered door 212 and opening 211C of the frame 211, a contact area may more increase than a linear shape and an amount of heated air which escapes from the housing 210 may be reduced, thereby reducing heat loss.

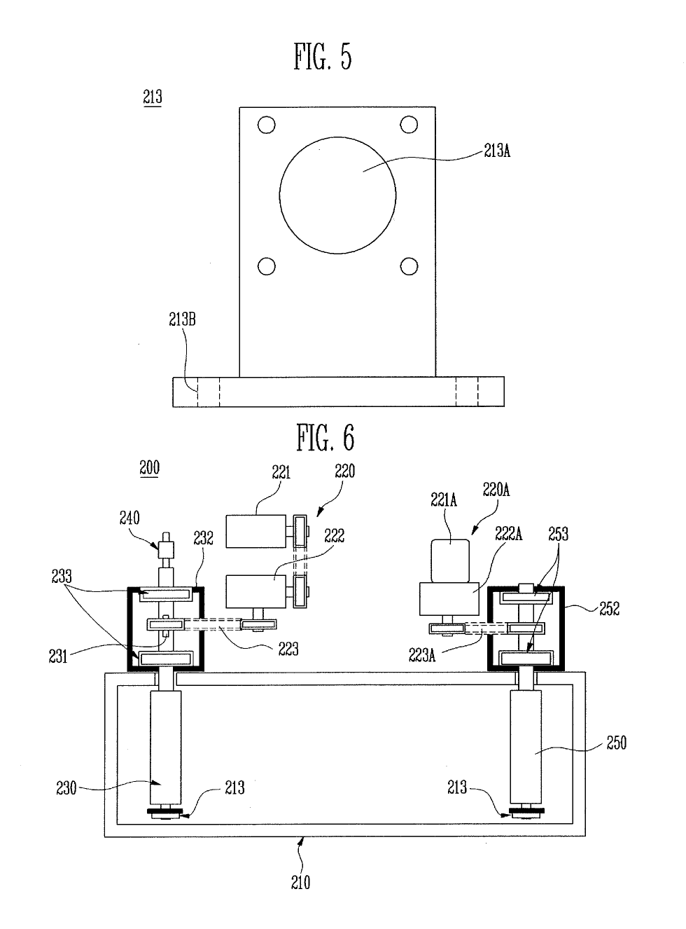

As shown in FIGS. 5 and 6 which are a front view of the bracket 213 and a top view of the heating device 200, the bracket 213 is a component for supporting and may support the inside of the frame 211, for example, may be provided on a bottom and may support the main roller 230 and the guide roller 250. The bracket 213 may be connected using bearings to allow the main roller 230 and the guide roller 250 to be rotatable.

As an example, the bracket 213 includes a hole 213A on an upper portion, through which the main roller 230 or the guide roller 250 penetrates. A member such as a bolt whose diameter is greater than the hole 213A is installed opposite to the main roller 230 or the guide roller 250 which penetrates through the hole 213A while disposing the bracket 213 therebetween, thereby preventing separation.

In addition, a lower portion of the bracket 213 protrudes from both sides to increase a contact area to be in contact with the frame 211 and to allow the bracket 213 to vertically stand. A bolt hole 213B is formed in the lower portion of the bracket 213 to be fixedly bolt-coupled with the frame 211. As described above, the bracket 213 is detachably installed on the frame 211 to be easily detached when it is necessary to maintain or repair the main roller 230 or the guide roller 250 due to a malfunction, thereby easily managing the same.

As shown in FIG. 6 which is a top view of the heating device 200, the driving units 220 and 220A include motors 221 and 221 A and decelerators 222 and 222A and transfer torques to the main roller 230 and the guide roller 250, respectively.

The motors 221 and 221A include motor shafts whose reference numerals are not shown in the drawing, and torques generated by the motors 221 and 221 A are transferred to the decelerators 222 and 222A by the motor shafts, respectively. Here, the decelerators 222 and 222A are components for reducing the torques of the motors 221 and 221A and transfer the torques of the motors 221 and 221A to one of the main roller 230 and the guide roller 250 to control a moving speed of the band stock 10.

Here, in case of connection between the motors 221 and 221A and the decelerators 222 and 222A, like being connected to the main roller 230, the motor 221 and the decelerator 222 may be connected through chains whose reference numeral is not shown. Here, the main roller 230 may include a key 231 formed of a groove in which a chain gear 223 is inserted. On the other hand, like being connected to the guide roller 250, the motor 221A and the decelerator 222A may be gear-connected (not shown).

The decelerators 222 and 222A which receive the torques from the motors 221 and 221A transfer the torques to the main roller 230 and the guide roller 250. Here, the chain gears 223 and 223A or belts are provided between the decelerator 222 and the main roller 230 and the decelerator 222A and the guide roller 250, respectively, to transfer the torques.

As shown in FIGS. 6 and 7 which are a top view and a front view of the heating device 200, the main roller 230 winds the band stock 10 which is wound around the guide roller 250 and moved toward the inlet 211 A to send the band stock 10 toward the outlet 211B, in which the band stock 10 may be cooled.

The main roller 230 may be installed next to the inlet 211A of the housing 210 opposite to the outlet 211B facing the moving direction of the band stock 10, for example, vertically thereto. The main roller 230 moves the band stock 10 which is input into the housing 210 and wound around the guide roller 250 toward the outlet 211B. Here, the band stock 10 is wound around the main roller 230 half a turn, thereby changing the moving direction. The main roller 230 may be installed facing the outlet 211B, for example, at a position corresponding to a height of the outlet 211B.

When the main roller 230 is higher than the guide roller 250, the main roller 230 is installed to allow a top thereof to be in a position corresponding to the height of the outlet 211B and the guide roller 250 is installed to allow a bottom thereof to be in a position corresponding to a height of the inlet 211A. Otherwise, when the main roller 230 is lower than the guide roller 250, the main roller 230 is installed to allow a bottom thereof to be in the position corresponding to the height of the outlet 211B and the guide roller 250 is installed to allow a top thereof to be in the position corresponding to the height of the inlet 211A. Accordingly, an exposed area of the band stock 10 may be maximized inside the housing 210.

Also, the band stock 10 is wound around the main roller 230 and then unwound therefrom and maintained to be horizontal to a top surface of the housing 210 to the outlet 211B to allow a distance from the heating unit 260 provided on an upper end of the housing 210 to be equal. Also, from the inlet 211A to the guide roller 250, the band stock 10 may be maintained to be horizontal to a bottom surface of the housing 210. Accordingly, the entire surface of the band stock 10 while moving from the main roller 230 to the outlet 211B and moving from the inlet 211A to the guide roller 250 is evenly heated by the heating units 260 provided on the top and bottom of the housing 210 to improve elongation quality in a process of being elongated by the elongation device 140A.

Also, the main roller 230 may include a box portion 232 and a box bracket 233 to be coupled with the housing 210. The main roller 230 may have a step between a front end and a rear end. The rear end of the main roller 230 may be installed to protrude outside from the frame 211 of the housing 210, and the box portion 232 in which the rear end of the main roller 230 is provided may be located in the rear end of the main roller 230. Here, a pair of box brackets 233 may be provided in the rear end of the main roller 230 to support the main roller 230 and may be fixed to the box portion 232.

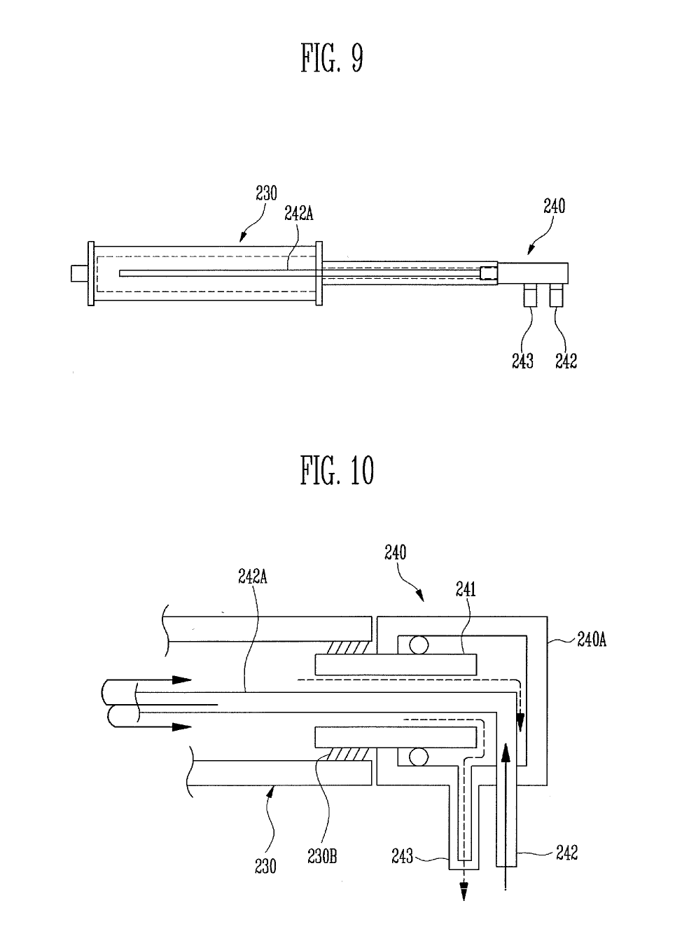

In addition, as shown in FIGS. 8 and 9, oil which is a refrigerant is input or output inside the main roller 230 and the main roller 230 is cooled by the oil to allow a temperature of the main roller 230 to be lower than the temperature of the housing 210 to be from about 50° C. to about 80° C.

This may be performed through the circulation of the oil inside the main roller 230. For this, a hollow portion 230A may be formed inside the main roller 230. Here, the front end of the main roller 230 winds the band stock 10 thereon and the rear end of the main roller 230 is connected to the driving unit 220 and includes the key 231 and bound by the frame 211 of the housing 210, in which the hollow portion 230A may be formed penetrating the front and rear ends of the main roller 230. Through the hollow portion 230A of the main roller 230 as described above, the oil flows. This is performed through the circulation of oil which flows into and from the rotary joint unit 240. It will be described below.

In addition, the main roller 230 may include a screw thread 230B to be coupled with the rotary joint unit 240. The screw thread 230B of the main roller 230 may be provided on a rear inner circumferential surface of the rear end of the main roller 230, through which the rotary joint unit 240 may penetrate to be coupled therewith.

The temperature of the main roller 230 described above is maintained to be lower than the temperature of the housing 210, thereby allowing the band stock 10 heated by a high temperature inside the housing 210 and the heating unit 260 to be cooled through being in contact with the main roller 230 having a lower surface temperature than the temperature inside the housing 210. Accordingly, since the band stock 10 may be cooled without being discharged outside the housing 210, it is unnecessary to discharge the band stock 10 to cool down after heating the band stock 10 in the housing 210. Since the band stock 10 is cooled through being in contact with the main roller 230 and then heated by the internal temperature of the housing 210 and the heating unit 260, it is unnecessary to provide an additional heating device, thereby reducing equipment and easily manufacturing the same.

In addition, as shown in FIG. 12 which is a front view of the heating device 201 according to another embodiment of the present invention, the heating device 201 may further include a pressing roller 201A on one side of the main roller 230 to be in contact therewith disposing the band stock 10 therebetween. Since the pressing roller 201A catches the band stock 10 together with the main roller 230, it is possible to omit a pressing device. Here, the pressing roller 201A closely supports the band stock 10 in such a way that the band stock 10 may be pushed by the rotation of the main roller 230 and the pressing roller 201A may be in an idle state and may be pushed and rotated by the band stock 10.

Additionally, like the pressing roller 201A and the main roller 230, an elongation roller (not shown) may be further provided on one side of the guide roller 250. Here, a rotational speed of the guide roller 250 may be lower than a rotational speed of the main roller 230. Accordingly, the band stock 10 between the guide roller 250 and the main roller 230 is caught and pulled due to the rotational speed of the main roller 230 higher than that of the guide roller 250, thereby performing elongation as a length extends.

As described above, since the band stock 10 may not only be moved but also pulled by the pressing roller 201A, the main roller 230, the guide roller 250, and the elongation roller provided in the heating device 201, it is possible to omit the elongation device 140 or the pressing device for moving and elongating the band stock 10 in front of the heating device 201, thereby simplifying equipment, reducing manufacturing costs, and improving space utilization.

Here, elongation performed at the heating device 201 may be relatively greater than elongation performed at the elongation device 140A. The elongation performed at the heating device 201 is to prevent the band stock 10 from being broken or twisted due to excessive elongation and elongating the band stock 10 to be up to a standard. The elongation performed at the elongation device 140A is an auxiliary process for preventing the band stock 10 from being nonstandard.

As shown in FIGS. 8 to 10 which are side views of the main roller 230 and the rotary joint unit 240, the rotary joint unit 240 may include a screw portion 241, a refrigerant inlet 242, and a refrigerant outlet 243. The main roller 230 is rotatably connected to the rotary joint unit 240 described above and the rotary joint unit 240 traverses inside the main roller 230 to be interconnected with the main roller 230 to allow the oil to flow inside the main roller 230.

The screw portion 241 may be rotary jointed with the main roller 230 to allow the main roller 230 to be rotatable. The screw portion 241 may have a screw thread formed on an outer circumferential surface thereof to be screw-coupled with the screw thread 230B of the main roller 230.

The refrigerant inlet 242 may receive the oil from an oil supplier (not shown) provided outside such as an oil tank and may input and supply the oil from the oil supplier into the main roller 230. Here, the refrigerant inlet 242 protrudes from the rear end and includes a screw thread on an outer circumferential surface or an inner circumferential surface to be coupled with a hose of the oil supplier.

In addition, the refrigerant inlet 242 forms an extending portion 242A having a pipe shape extending long forward in such a way that a front of the refrigerant inlet 242 penetrates the front end of the main roller 230, thereby easily inputting the oil to a front of the hollow portion 230A of the main roller 230. Here, the extending portion 242A extends penetrating through the screw portion 241. When the screw portion 241 rotates together in connection with the main roller 230, the extending portion 242A is in a fixed state.

The refrigerant outlet 243 allows the oil input into the main roller 230 to be discharged to provide room inside the main roller 230 to continuously supply the oil. The refrigerant outlet 243 described above may be provided to protrude from the rear end to be separate from the refrigerant inlet 242 to discharge the oil from the main roller 230 and may include a screw thread to be connected to an external oil discharger (not shown). Here, unlike the extending portion 242A of the refrigerant inlet 242 which is inserted into the hollow portion 230A of the main roller 230, the refrigerant outlet 243 may be interconnected with the hollow portion 230A of the main roller 230 facing each other to allow the oil discharged from the hollow portion 230A to pass through the refrigerant outlet 243 and to be discharged outside. A circulation configuration of the oil through the rotary joint unit 240 will be described as follows.

As shown in FIG. 10 in which a solid line indicates an inflow of the oil and a dotted line indicates the discharge of the oil, the rotary joint unit 240 includes a body 240A which is formed by connecting the refrigerant inlet 242, the refrigerant outlet 243, and the screw portion 241.

In a state in which an opening is formed on one side of the body 240A and the screw portion 241 is supported by a bearing whose reference numeral is not shown to protrude from the opening of the body 240A to fix the body 240A, the screw portion 241 is interconnected with the main roller 230 and rotated. Here, to allow the oil to flow between the screw portion 241 and the extending portion 242A, the extending portion 242A penetrating the screw portion 241 is provided to be separate from an inner circumferential surface of the screw portion 241.

Here, in the case of the refrigerant inlet 242, the extending portion 242A is provided to penetrate the body 240A, to be partitioned from the inside of the body 240A, and to extend toward the hollow portion 230A of the main roller 230, in which the oil supplied through the refrigerant inlet 242 may pass through the extending portion 242A and may flow into the hollow portion 230A of the main roller 230. Also, the refrigerant outlet 243 is integrated with the body 240A to be interconnected with the inside of the body 240A to allow the oil discharged from the hollow portion 230A of the main roller 230 to pass through the body 240A and the refrigerant outlet 243 and to be discharged outside.

The rotary joint unit 240 described above may adjust a temperature of the supplied oil to allow the temperature of the oil inside the main roller 230 to be uniform to perform equal cooling so as to uniformly elongate the band stock 10. For example, a heat sensor is provided in the refrigerant outlet 243 to measure the temperature of the discharged oil in such a way that heat applied to the oil is adjusted depending on the temperature of the discharged oil, thereby adjusting the temperature of the oil supplied to the refrigerant inlet 242.

As shown in FIGS. 6 and 7 which are the top view and front view of the heating device 200, the guide roller 250 is a component which winds the band stock 10 input through the inlet 211A and may be installed to traverse the inside of the housing 210 to allow the band stock 10 to hang thereover, and the guide roller 250 is adjacent to the outlet 211B opposite to the inlet 211A of the housing 210, and for example may be installed to be perpendicular to the moving direction of the hand stock 10.

The guide roller 250 winds and moves the band stock 10 toward the inlet 211 A again, which may be performed through that the band stock 10 is wound around the main roller 230 half a turn to allow a winding direction and the moving direction to face each other.

The guide roller 250 described above may be installed to be opposite to the inlet 211A to allow the band stock 10 to be horizontally input and wound therearound, for example, at a position corresponding to the height of the inlet 211A.

Here, the guide roller 250 and the main roller 230 may be separate from each other while the top and bottom positions thereof cross each other in such a way that the main roller 230 may not disturb a route of the band stock 10 which is input to and output from the housing 210, that is, a path from the inlet 211A toward the guide roller 250 and the guide roller 250 may not disturb the route of the band stock 10 which is wound around the main roller 230 and moved toward the outlet 211B.

Here, the inlet 211 A and the outlet 211B of the housing 210 may be provided in the housing 210 to allow the top and bottom positions thereof to differ as a length corresponding to a radius of one of the main roller 230 and the guide roller 250.

As described above, in the embodiment of the present invention, the main roller 230 and the guide roller 250 are disposed to cross each other and the band stock 10 is allowed to be wound around the guide roller 250 and then wound around the main roller 230, thereby allowing the band stock 10 to pass through the inside of the housing 210 in a zigzag shape and to be discharged. Accordingly, it is unnecessary to horizontally extend a width of the housing 210, thereby efficiently using a space.

Here, a key (not shown) into which the chain gear 223A is insertable may be formed in the guide roller 250, which is identical or similar to that of the main roller 230.

The heating unit 260 is a component for supplying heat to heat the band stock 10, which may heat the inside of the housing 210, may be formed of a heater, and may be provided at both the top and bottom of the inside of the frame 211 of the housing 210. Here, the heater may be a ceramic heater.

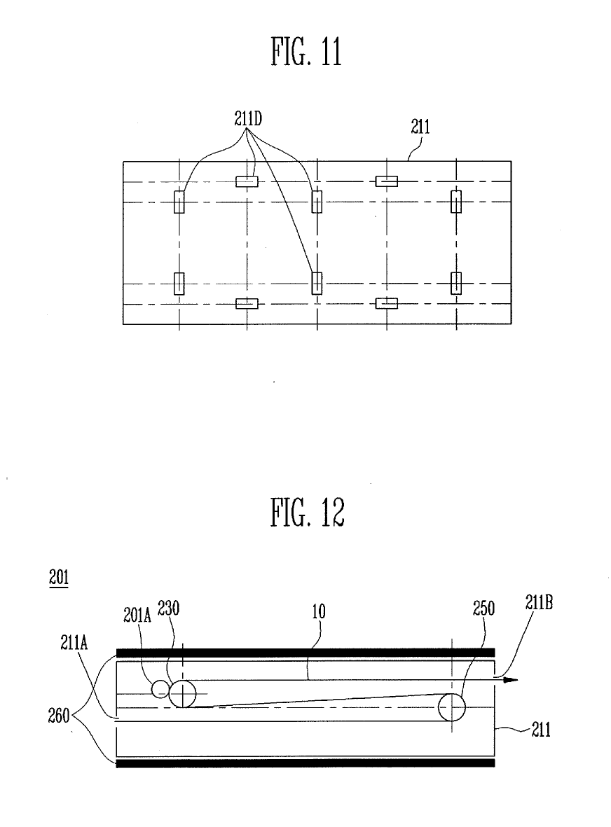

As shown in FIG. 11, a heat mounting plate 211D on which the ceramic heater is mounted may be provided on circumferences of the top and bottom of the frame 211 and the middles thereof. The heater mounting plates 211D may be separate and disposed with equidistant intervals not to allow the ceramic heater to interfere with one another.

In the embodiment of the present invention, the main roller 230 is provided next to the inlet 211A and the guide roller 250 is provided next to the outlet 211B. However, a guide roller may be provided next to the inlet 211A and a main roller may be provided next to the outlet 211B. In this case, a rotational speed of the guide roller may be higher than a rotational speed of the main roller to perform elongation.

As described above, in the embodiments of the present invention, since it is possible to heat, cool, and heat the band stock 10 in one of the heating devices 200 and 201 without cooling the inside of the housing 210, it is unnecessary to provide a plurality of heating devices 200 and 201 to reheat the band stock 10 and a pressing device for catching the band stock 10 between the heating devices 200 and 201 not to allow the band stock 10 to droop may be omitted, thereby simplifying equipment.

According to the embodiments of the present invention, in a heating device and a packing band manufacturing apparatus including the same, since it is possible to heat, cool, and heat a band stock without cooling the inside of a housing in one heating device, it is unnecessary to provide a plurality of heating devices to reheat the band stock and it is possible to omit a pressing device for catching the band stock, thereby simplifying equipment.

Also, speeds of a main roller and a guide roller differ from each other to move the band stock while pulling the band stock to perform elongation in such a way that an elongation device for holding and elongating the band stock in front of the heating device may be omitted, thereby simplifying equipment, reducing manufacturing costs, and improving space utilization.

Also, the band stock passing through the heating device in the housing face the heating device with equidistant intervals in such a way that the entire surface of the band stock are evenly heated to improve elongation properties.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A heating device comprising:
a housing through which a band stock is input and output;
a main roller provided to traverse the inside of the housing to allow the band stock to hang thereover, inside which a refrigerant circulates to maintain a surface temperature thereof to be lower than an internal temperature of the housing;
a rotary joint unit which traverses the inside of the main roller to be interconnected with the main roller to allow the refrigerant to flow through and circulate the inside of the main roller;
a guide roller separate from the main roller to allow top and bottom thereof to cross each other in the housing, over which the band stock hangs; and
a heating unit which heats the inside of the housing,
wherein the band stock input into the housing is heated by the heating unit, turns around the guide roller, is wound around the main roller to be cooled by the surface temperature of the main roller, is reheated by the heating unit, and is discharged from the housing, or the band stock is heated by the heating unit, turns around the main roller to be cooled by the surface temperature of the main roller, is wound around the guide roller, is reheated by the heating unit, and is discharged from the housing.

2. The heating device of claim 1, wherein the rotary joint unit comprises:
a screw portion rotary-jointed with the main roller to rotate the main roller;
a refrigerant inlet through which the refrigerant is supplied to the main roller; and
a refrigerant outlet through which the refrigerant is discharged from the main roller.

3. The heating device of claim 1, further comprising a pressing roller provided on one side of one of the main roller and the guide roller to be in contact therewith disposing the band stock therebetween.

4. The heating device of claim 3, wherein the pressing roller is provided on one side of one of the main roller and the guide roller and an elongation roller is further provided on one side of the other of the main roller and the guide roller.

5. The heating device of claim 4, further comprising driving units which rotate the main roller and the guide roller, respectively, wherein a rotational speed of the main roller driven by the driving unit is higher than a rotational speed of the guide roller driven by the driving unit to elongate the band stock.

6. The heating device of claim 1, wherein the housing comprises:
a frame comprising an inlet through which the band stock is input, an outlet through which the band stock is discharged, and an opening;
a door which opens and closes the opening; and
brackets provided on the frame to support the main roller and the guide roller, respectively.

7. The heating device of claim 6, wherein the door comprises a projective window through which the inside of the housing is projected outside.

8. The heating device of claim 1, wherein the housing comprises lagging which prevents the heated internal temperature from escaping.

9. The heating device of claim 1, wherein the internal temperature of the housing is from about 100° C. to about 130° C., and
wherein a temperature of the main roller is from about 50° C. to about 80° C.

10. The heating device of claim 1, wherein the refrigerant is formed of oil.

11. A packing band manufacturing apparatus comprising:
a hopper through which a raw material is input;
an extruder which receives the raw material from the hopper and extrude the raw material to discharge a band stock;
a cooling device through which the band stock passes to be hardened; and
a heating device which receives the band stock from the cooling device and heats the band stock,
wherein the heating device comprises:
a housing through which the band stock is input and output;
a main roller provided to traverse the inside of the housing to allow the band stock to hang thereover, inside which a refrigerant circulates to maintain a surface temperature thereof to be lower than an internal temperature of the housing;
a rotary joint unit which traverses the inside of the main roller to be interconnected with the main roller to allow the refrigerant to flow through and circulate the inside of the main roller;
a guide roller separate from the main roller to allow top and bottom thereof to cross each other in the housing, over which the band stock hangs; and
a heating unit which heats the inside of the housing,
wherein the band stock input into the housing is heated by the heating unit, turns around the guide roller, is wound around the main roller to be cooled by the surface temperature of the main roller, is reheated by the heating unit, and is discharged from the housing, or is heated by the heating unit, turns around the main roller to be cooled by the surface temperature of the main roller, is wound around the guide roller, is reheated by the heating unit, and is discharged from the housing.

12. The packing band manufacturing apparatus of claim 11, wherein the rotary joint unit comprises:
a screw portion rotary-jointed with the main roller to rotate the main roller;
a refrigerant inlet through which the refrigerant is supplied to the main roller; and
a refrigerant outlet through which the refrigerant is discharged from the main roller.

13. The packing band manufacturing apparatus of claim 11, wherein the pressing roller is provided on one side of one of the main roller and the guide roller and an elongation roller is further provided on one side of the other of the main roller and the guide roller to be in contact therewith disposing the band stock therebetween,
further comprising driving units which rotate the main roller and the guide roller, respectively, and
wherein a rotational speed of the main roller driven by the driving unit is higher than a rotational speed of the guide roller driven by the driving unit to elongate the band stock.
